(19) United States
(12) Patent Application Publication
(10) Pub. No.: US 2014/0184923 A1
(43) Pub. Date: Jul. 3, 2014

(54) OUTPUT METHOD AND OUTPUT SYSTEM

(71) Applicant: Fujitsu Mobile Communications Limited, Kawasaki-shi (JP)

(72) Inventor: Yasuhiko ABE, Niiza (JP)

(73) Assignee: Fujitsu Mobile Communications Limited, Kawasaki-shi (JP)

(21) Appl. No.: 14/061,105

(22) Filed: Oct. 23, 2013

(30) Foreign Application Priority Data
Dec. 27, 2012 (JP) 2012-284449

(51) Int. Cl. H04N 5/44

(52) U.S. Cl. CPC H04N 5/4403
USPC 348/734

(57) ABSTRACT

A disclosed output method includes: receiving, from an output apparatus of plural output apparatuses, notification that represents that a radio wave from a portable apparatus was received; and causing the output apparatus that received the radio wave to restart both or either of an image output and a sound output, which were stopped, for example, in another output apparatus of the plural output apparatuses after detecting that no radio wave was received from the portable apparatus. For example, when the timing of the stop in the image such as video and/or sound is stored, the output apparatus restarts both or either of the image output and the sound output from the stored timing.

### CROSS-REFERENCE TO RELATED APPLICATIONS

This application is based upon and claims the benefit of priority of the prior Japanese Patent Application No. 2012-284449, filed on Dec. 27, 2012, the entire contents of which are incorporated herein by reference.

### FIELD

This invention relates to a technique for controlling output of at least one of an image and sound.

### BACKGROUND

In a certain conventional art, when reproduction of contents such as video and sound is discontinued at an electronic appliance connected to a home network, reproduction information is held in a portable reproduction control apparatus such as a cellular phone. According to this conventional art, it is possible to easily restart watching or listening with another electronic appliance connected to the home network by using the reproduction information.

In this conventional art, the discontinuation and restart of the contents reproduction are carried out in response to an operation against a controller. Therefore, it is troublesome for the user to perform an operation for each of the discontinuation and restart.

Moreover, in another conventional art, when transmitting a search signal from an electric product such as television, which is operated by a remote controller, the remote controller receives the search signal and emits an informing signal such as sound or light toward the outside. Accordingly, it is possible to easily find the remote controller that cannot be found.

An object of this conventional art is to inform the user of the position of the remote controller, and this conventional art does not relate to a main operation of the electric product such as the television.

As one aspect, an object of this invention is to provide a technique for simplifying operations related to outputs of at least one of the image and sound.

### SUMMARY

An output method relating to an aspect of this invention includes: (A) receiving, from an output apparatus of plural output apparatuses, notification that represents that a radio wave from a portable apparatus was received; and (B) first causing the output apparatus that received the radio wave to restart both or either of an image output and a sound output, which were stopped.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an example of a network relating to a contents reproduction system;

FIG. 2 is a diagram depicting a first state relating to the contents reproduction system;

FIG. 3 is a diagram depicting an example of definition about levels of radio waves;

FIG. 4 is a diagram depicting an example of data of a portable terminal in the first state;

FIG. 5 is diagram depicting an example of contents management data in the first state;

FIG. 6 is a diagram depicting a second state relating to the contents reproduction system;

FIG. 7 is a diagram depicting an example of data of a portable terminal in the second state;

FIG. 8 is a diagram depicting an example of contents management data in the second state;

FIG. 9 is a diagram depicting a third state relating to the contents reproduction system;

FIG. 10 is a diagram depicting an example of data of a portable terminal in the third state;

FIG. 11 is a diagram depicting an example of contents management data in the third state;

FIG. 12 is a diagram depicting an example of a sequence in the contents reproduction system;

FIG. 13 is a diagram depicting an example of a sequence in the contents reproduction system;

FIG. 14A is a diagram depicting an example of a sequence in the contents reproduction system;

FIG. 14B is a diagram depicting an example of a sequence in the contents reproduction system;

FIG. 15 is a diagram depicting an example of a modular configuration of a server;

FIG. 16 is a diagram depicting an example of a modular configuration of a display apparatus;

FIG. 17 is a diagram depicting an example of a modular configuration of a portable terminal;

FIG. 18 is a diagram depicting an example of a processing flow by a controller in the display apparatus;

FIG. 19 is a diagram depicting an example of a processing flow of a processing for a contents search request in the display apparatus;

FIG. 20 is a diagram depicting an example of a processing flow by a controller in the server;

FIG. 21 is a diagram depicting an example of a processing flow of a processing for the contents search request in the server;

FIG. 22 is a diagram depicting an example of a processing flow of a processing for a contents reproduction request;

FIG. 23 is a diagram depicting an example of a processing flow of a processing for departure determination;

FIG. 24 is a diagram depicting an example of a processing flow of a processing for a discontinuation request;

FIG. 25 is a diagram depicting an example of a processing flow of a processing for a monitor request;

FIG. 26 is a diagram depicting an example of a processing flow of a processing for arrival determination;

FIG. 27 is a diagram depicting an example of a processing flow of a processing for restart determination;

FIG. 28 is a diagram depicting an example of a processing flow of a processing for a contents display request;

FIG. 29 is a diagram depicting a first example of a sequence for stop and restart of the departure determination;

FIG. 30 is a diagram depicting a second example of a sequence for stop and restart of the departure determination; and

FIG. 31 is a functional block diagram of a computer.

### DESCRIPTION OF EMBODIMENTS

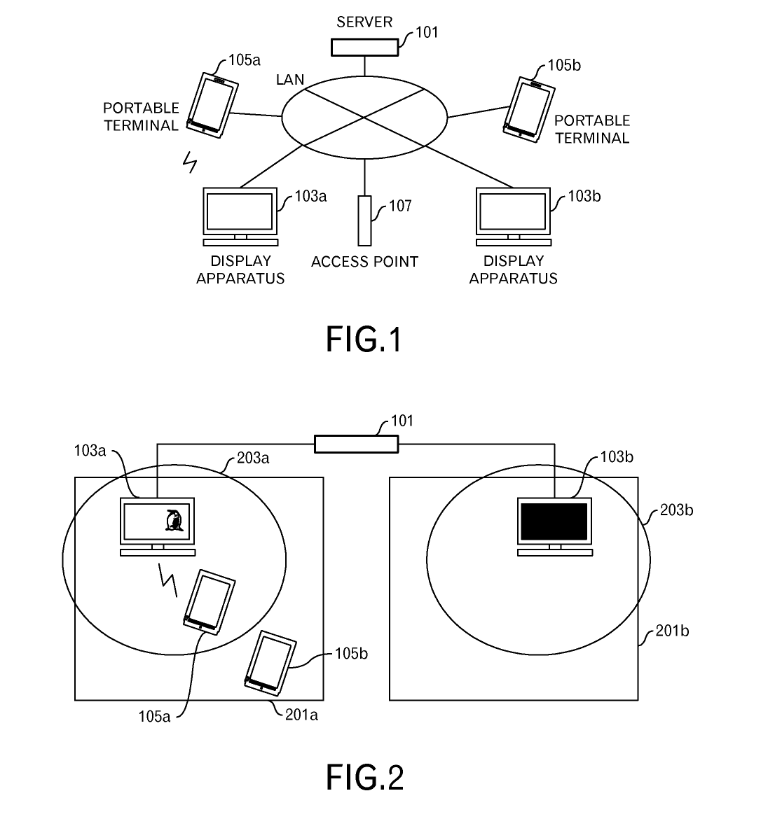

FIG. 1 illustrates an example of a network relating to a contents reproduction system. In this example, the contents reproduction system has a server 101, a display apparatus 103a, display apparatus 103b, portable terminal 105a, portable terminal 105b and access point 107. The server 101, display apparatus 103a, display apparatus 103b, portable terminal 105a, portable terminal 105b and access point 107 are connected through a Local Area Network (LAN) by wire or wireless. Moreover, the server 101, display apparatus 103a, display apparatus 103b, portable terminal 105a and portable terminal 105b communicate each other by a protocol to make devices have the compatibility such as Digital Living Network Alliance (DLNA).

The server 101 has a medium device that stores source data of contents (e.g. compressed video data or sound data), and is an apparatus to provide other apparatuses with the contents reproduced by the decoding, for example. The server 101 is a Digital Versatile Disk (DVD) recorder, for example. The contents are information such as videos like movie or sounds like music.

The display apparatus 103a and display apparatus 103b are examples of a display apparatus 103 that displays reproduced video data. Furthermore, the display apparatus 103 outputs reproduced sound data. The display apparatus 103 has a render function, for example, and has a display device to display videos and a speaker to output sounds. The display apparatus 103 is an example of an output apparatus to output reproduced data of contents (e.g. decompressed video data or sound data). The output apparatus may be a digital television, desktop personal computer (PC), laptop PC or projector. One output apparatus may be connected or plural output apparatuses may be connected. For example, each room in a house may include any one of plural output apparatuses.

The portable terminal 105a and portable terminal 105b are examples of a portable terminal 105 that has a controller function for the display apparatus 103. The portable terminal 105 is an example of a portable apparatus. The portable terminal 105 is a smart phone, for example. Or the portable terminal 105 may be a dedicated controller.

Moreover, both of the display apparatus 103 and portable terminal 105 have a near field communication function. Therefore, it is presumed that the display apparatus 103a performs the near field communication with the portable terminal 105a or portable terminal 105b, and the display apparatus 103b performs the near field communication with the portable terminal 105a or portable terminal 105b. Moreover, the display apparatus 103 and portable terminal 105 perform a pairing operation between apparatuses as presumption of the near field communication. The display apparatus 103 has a function to identify the strength of the radio wave received from the portable terminal 105 and to identify the portable terminal 105 that is a transmission source of the radio wave by the pairing operation.

In the contents reproduction system relating to this embodiment, along with the movement of the user who watches and/or listens the contents, one of the display apparatuses 103 (e.g. display apparatus 103a) discontinues the display of the contents and the other display apparatus 103 (e.g. display apparatus 103b) restarts the display of the contents. In the following, an outline of operations relating to the movement of the user by the contents reproduction system will be explained.

FIG. 2 illustrates a first state relating to the contents reproduction system. Room 201a is a first room included in a house. Room 201b is a second room included in the same house as the room 201a, for example. The display apparatus 103a is a first display apparatus installed in the room 201a. The display apparatus 103b is a second display apparatus installed in the room 201b. The server 101 is connected to the display apparatus 103a and display apparatus 103b, as illustrated in FIG. 1. A communication area 203a schematically represents a range in which it is presumed that the portable terminal 105 that is the source of the radio wave exists when receiving the radio wave having predetermined strength or more in the display apparatus 103a. Similarly, a communication area 203b schematically represents a range in which it is presumed that the portable terminal 105 that is the source of the radio wave exists when receiving the radio wave having predetermined strength or more in the display apparatus 103b.

In this first state, the server 101 reproduces the contents. For example, the server 101 continuously performs a decoding processing. Then, data of the reproduced contents is sent to the display apparatus 103a. The display apparatus 103a displays a video included in the contents based on the received data, and further outputs sounds included in the contents from the speaker through an amplifier. In this example, the user who watches and/or listens the contents holds the portable terminal 105a. At this time, the portable terminal 105a is within the communication area 203a. The portable terminal 105b is in the room 201a, however, outside the communication area 203a. For example, another person holds the portable terminal 105b. At this time, the display apparatus 103a detects that the portable terminal 105a is in the communication area 203a by the radio wave for the near field communication.

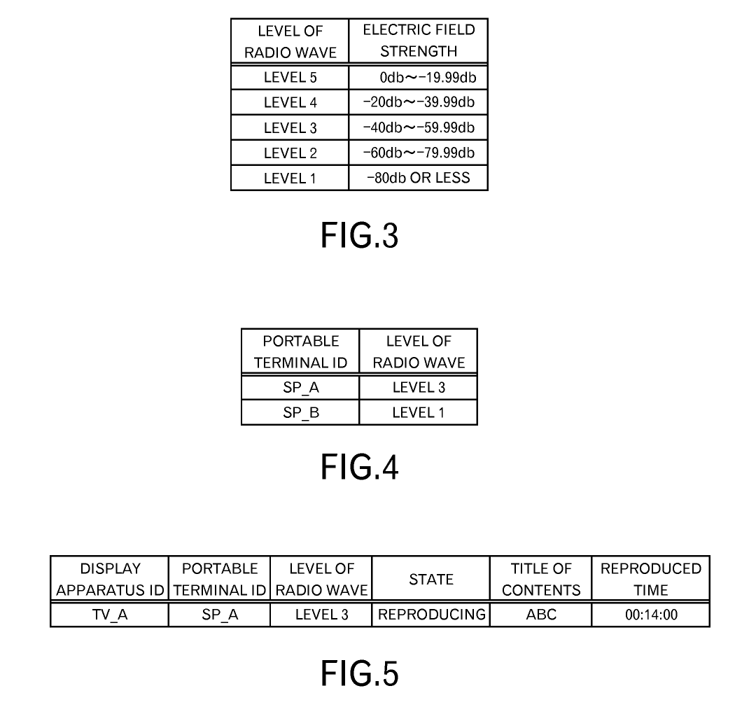

In this embodiment, the levels of the radio wave are defined according to the electric field strength. FIG. 3 illustrates an example of the definition of the levels of the radio wave. When the electric field strength is in a range from 0 dB to −19.99 dB, the level of the radio wave is “level 5”. Furthermore, the electric field strength of the level 5 is strongest, and the radio wave becomes weak in order of level 4, level 3, level 2 and level 1. When the electric field strength is in a range from −20 dB to −39.99 dB, the level of the radio wave is level 4, when the electric field strength is in a range from −40 dB to −59.99 dB, the level of the radio wave is level 3, and when the electric field strength is in a range from −60 dB to −79.99 dB, the level of the radio wave is level 2. The level 1 at which radio wave is weakest represents the electric field strength is equal to or less than −80 dB. In this example, when the level of the radio wave is either of the levels 5 to 2, it is assumed that the user who holds the portable terminal 105 is in an area appropriate to watch and/or listen the contents. The area appropriate to watch and/or listen the contents corresponds to the communication area 203a and communication area 203b.

Moreover, the display apparatus 103a saves data for the portable terminal 105 that is paired with this display apparatus 103a. FIG. 4 illustrates an example of data for the portable terminal in the first state. A record is provided for each portable terminal 105 that is paired with its own apparatus. The record includes items for a portable terminal identifier (ID) and level of the radio wave. The portable terminal ID represents identification information of the portable terminal 105 that is paired with its own apparatus. The level of the radio wave represents the level of the radio wave received from the portable terminal 105 that is paired with its own apparatus. In this example, the first record represents data concerning the portable terminal 105a. Specifically, as for the portable terminal 105 that is paired with the display apparatus 103a, the portable terminal ID is “SP_A”, and the level of the radio wave that was received at the pairing is the level 3. The second record represents data concerning the portable terminal 105b. Specifically, the portable terminal ID of the portable terminal 105b is “SP_B”, and the level of the radio wave that was received at the pairing is the level 1. An item to represent whether or not information of this record has been registered in the server 101 may be provided.

Returning to the explanation of FIG. 2, the display apparatus 103b do not display any contents. Moreover, no portable terminal 105 exists in the room 201b. Therefore, the display apparatus 103b do not has data of the portable terminal.

Moreover, the server 101 saves data concerning the contents which are being reproduced by itself or whose reproduction is temporarily discontinued. FIG. 5 illustrates an example of contents management data in the first state. The contents management data includes a record for each of the contents, which is being reproduced or whose reproduction is discontinued. The record includes items for a display apparatus ID, portable terminal ID, level of the radio wave, state, title of the contents and reproduced time.

The display apparatus ID is identification information of the display apparatus 103 which is a transmission destination of the reproduced data of the contents. The portable terminal ID is identification information of the portable terminal 105 that is in the communication area 203 of the display apparatus 103 that is the transmission destination. The level of the radio wave is the level of the radio wave that was received from the portable terminal 105 at the pairing by the display apparatus 103 of the transmission destination. The state represents reproducing or discontinued. The title of the contents is a title of the contents that are being reproduced or discontinued. The reproduced time represents a period up to a current reproduction time in case of being reproduced or a period up to the discontinuation timing in case of being discontinued.

The first record in FIG. 5 represents that the server 101 reproduced the contents whose title is “ABC” up to “00:14:00”, and is further reproducing. Furthermore, this record also represents that the display apparatus ID of the display apparatus, which is the transmission destination of the contents, is “TV_A”, and the display apparatus 103a receives the radio wave whose strength is level 3, and the portable terminal ID of the portable terminal which transmitted the radio wave is “SP_A”. There is no second record and subsequent records, therefore, no contents are reproduced or discontinued.

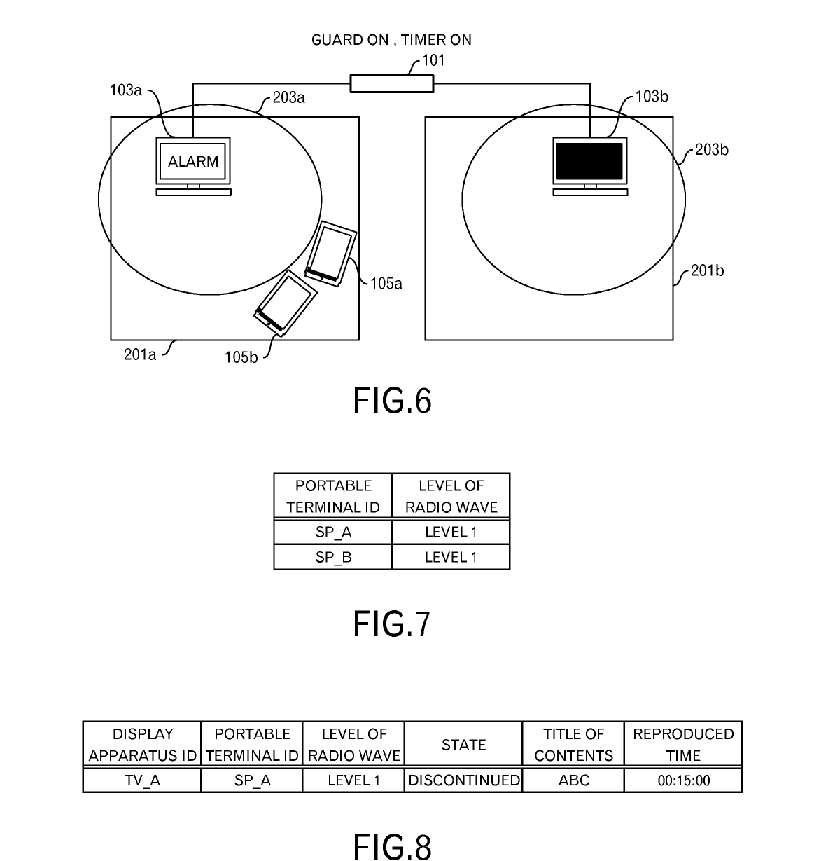

Next, the second state after the first state will be explained. FIG. 6 illustrates the second state concerning the contents reproduction system. The user who holds the portable terminal 105a and was watching and/or listening the contents in the first state is moving toward the room 201b. The portable terminal 105a goes out of the communication area 203a. The portable terminal 105b does not move.

The display apparatus 103a detects, by the pairing, that the portable terminal 105a goes out of the communication area 203a. FIG. 7 illustrates an example of data of the portable terminal 105, which is saved by the display apparatus 103a in the second state. The first record represents data concerning the portable terminal 105a. The first records represents that the level of the radio wave for the portable terminal 105a whose portable terminal ID is “SP_A” became level 1. The second record represents data concerning the portable terminal 105b, and is the same as that in FIG. 4. As for the display apparatus 103b, there is no data of the portable terminal in the second state, similarly to the first state.

Returning to the explanation of FIG. 6, when the display apparatus 103a detects that the portable terminal 105a goes out of the communication area 203a, the display apparatus 103a displays an alarm. Then, when a predetermined period elapsed since the alarm, the display apparatus 103a stops the display of the contents, and the server 101 discontinues the reproduction of the contents.

FIG. 8 illustrates an example of the contents management data held by the server 101 in the second state. The display apparatus ID “TV_A”, portable terminal ID “SP_A” and title of the contents “ABC” in the first record are the same as those in the first record in FIG. 5 which represents in the first state. However, the level of the radio wave becomes level 1, and the state becomes “discontinued”. Moreover, the reproduced time represents the time from the start to notification of the discontinuation is “00:15:00”. There are no second record and subsequent records.

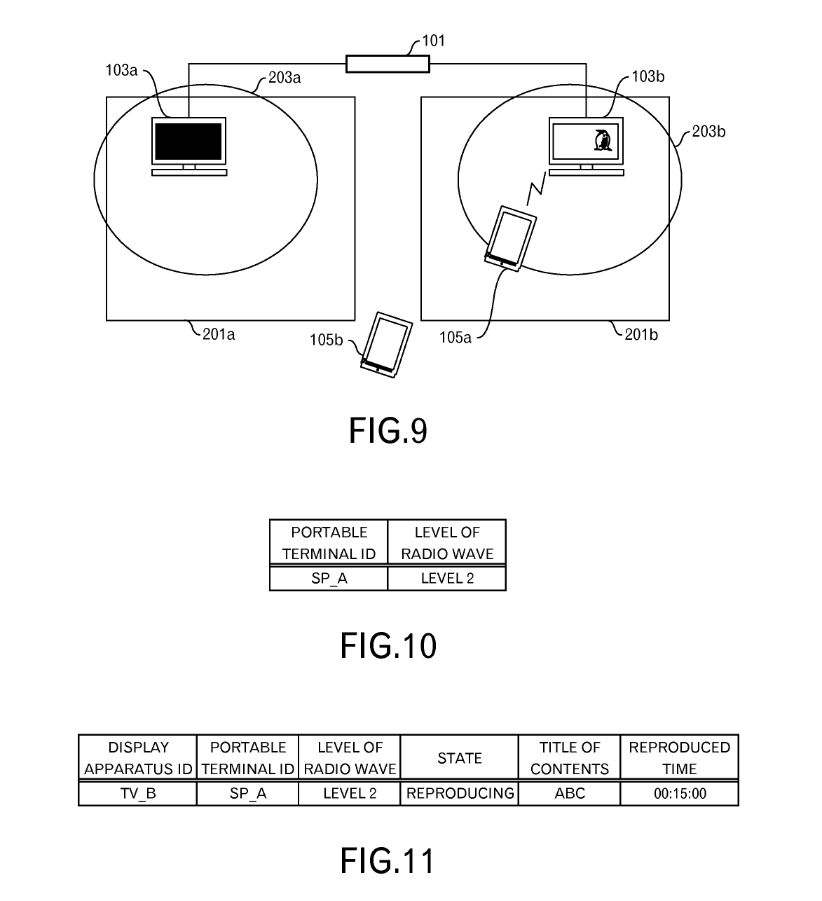

Next, the third state after the second state will be explained. FIG. 9 illustrates the third state for the contents reproduction system. The user who has the portable terminal 105a enters into the room 201b, and approaches the display apparatus 103b. At this time, the portable terminal 105a is in the communication area 203b. When the display apparatus 103b detects the portable terminal 105a within the communication area 203b, the server 101 restarts the reproduction of the contents, and display apparatus 103b displays continuation of the contents. Thus, the user can watch and/or listen the contents without any interval.

FIG. 10 illustrates an example of data of the portable terminal, which is saved by the display apparatus 103b in the third state. The first record represents data concerning the portable terminal 105a. Specifically, as for the portable terminal 105a that is paired with its own apparatus, the portable terminal ID is “SP_A” and the level of the radio wave that was received in the pairing is level 2. There are no second record and subsequent records.

The portable terminal 105b goes out of the room 201a, and is at the position where the display apparatus 103a and display apparatus 103b do not detect the portable terminal 105b. Therefore, there is no data for the portable terminal 105b in the display apparatus 103b.

FIG. 11 illustrates an example of the contents management data that is saved by the server 101 in the third state. The first record in FIG. 11 represents that the server 101 restarts the reproduction of the contents whose title is “ABC” from “00:15:00”. Furthermore, the first record represents that the display apparatus ID of the transmission destination of the contents is “TV_B”, and the display apparatus 103b receives the radio wave whose strength level is level 2, and the portable terminal ID of the portable terminal that transmits the radio wave is “SP_A”. Because there are no second record and subsequent records, other contents are not reproduced or discontinued.

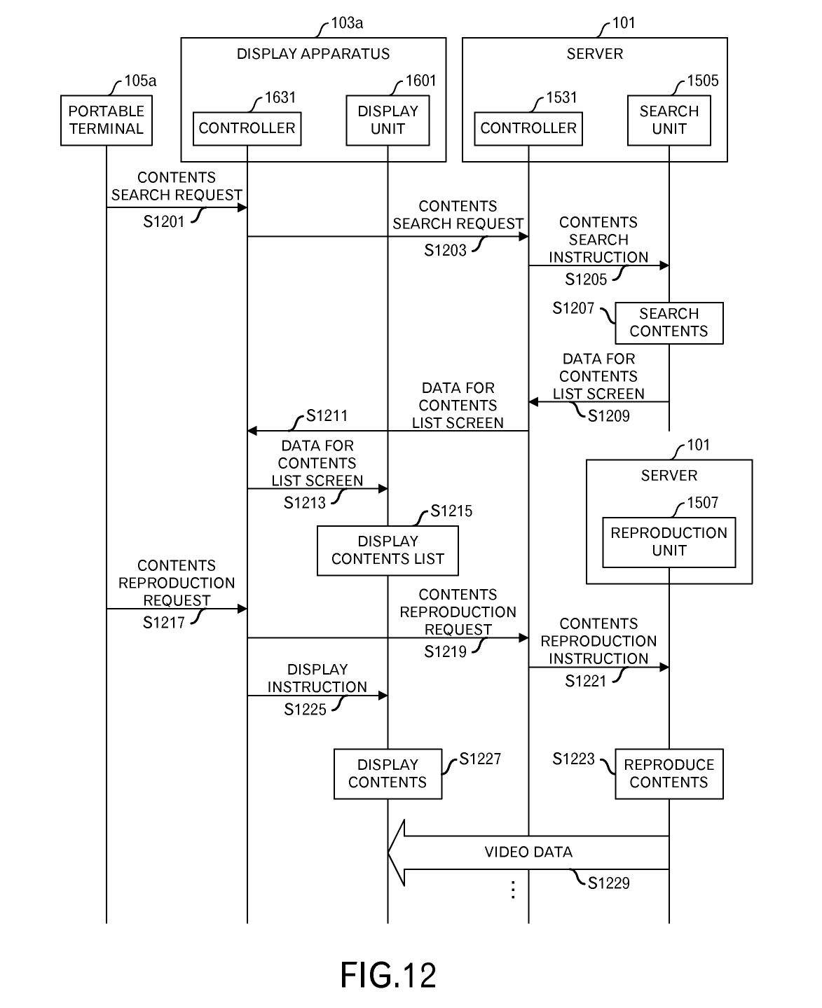

Next, sequences executed by the contents reproduction system will be explained by using FIGS. 12 to 14B according to the aforementioned operational outline.

FIG. 12 illustrates a flow of a sequence from the timing of the contents search to the timing of the beginning of the contents display. FIG. 12 illustrates a main processing and data flow among the portable terminal 105a, display apparatus 103a and server 101.

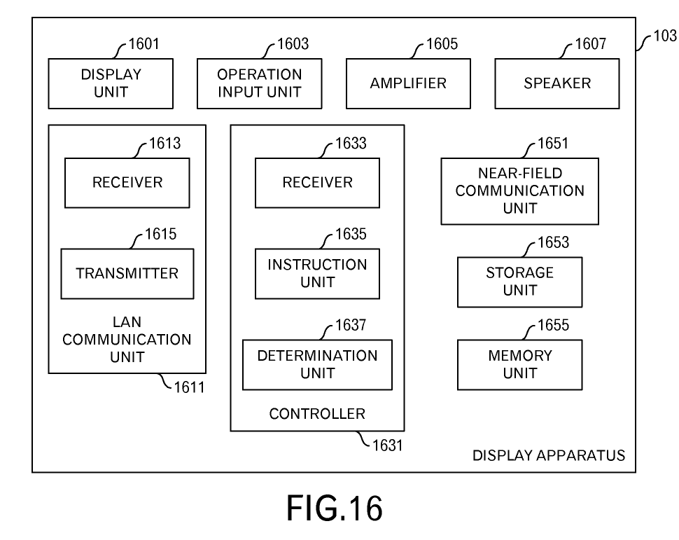

As for the display apparatus 103a, a process by a controller 1631 and a process by a display unit 1601 are illustrated. The controller 1631 is a module for mainly controlling cooperation with other apparatuses. The display unit 1601 is a module for performing a display processing. The module configuration of the display apparatus 103 will be explained by using FIG. 16.

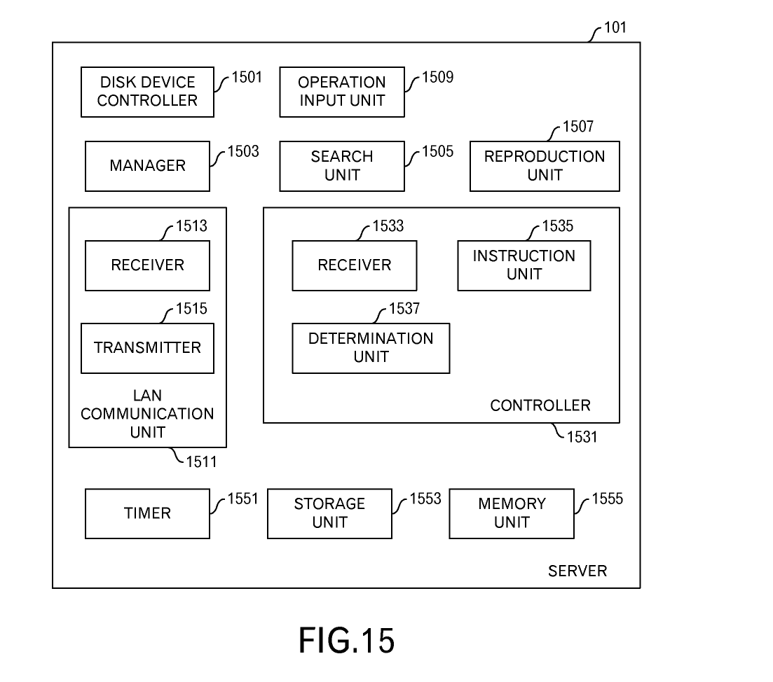

Moreover, as for the server 101, a process by a controller 1531, a process by a search unit 1505 and a process by a reproduction unit 1507 are illustrated. The controller 1531 is a module for mainly controlling the cooperation with other apparatuses. The search unit 1505 is a module for performing the search of the contents. The reproduction unit 1507 is a module for reproducing the contents. The module configuration of the server 101 will be explained by using FIG. 15.

When the user operates the portable terminal 105a, and instructs the search of the contents, the portable terminal 105a transmits a contents search request to the display apparatus 103a (S1201). The controller 1631 of the display apparatus 103a transfers the contents search request to the server 101 (S1203).

When the server 101 receives the contents search request, the controller 1531 of the server 101 outputs a contents search instruction to the search unit 1505 of the server 101 (S1205). The search unit 1505 of the server 101 performs the search of the contents (S1207), and returns data for a contents list screen based on the search result to the controller 1531 of the server 101 (S1209). The controller 1531 of the server 101 transmits the data for the contents list screen to the display apparatus 103a (S1211).

When the display apparatus 103a receives the data for the contents list screen, the controller 1631 of the display apparatus 103a outputs the data for the contents list screen to the display unit 1601 of the display apparatus 103a (S1213), and the display unit 1601 of the display apparatus 103a displays the contents list screen (S1215).

The user watches the contents list screen displayed on the display apparatus 103a, operates the portable terminal 105a, selects any one of the contents and instructs the portable terminal 105a to reproduce the selected contents. In response to this instruction, the portable terminal 105a transmits a contents reproduction request to the display apparatus 103a (S1217). The contents reproduction request includes information to identify the selected contents.

When the display apparatus 103a receives the contents reproduction request, the controller 1631 of the display apparatus 103a transfers the contents reproduction request to the server 101 (S1219).

When the server 101 receives the contents reproduction request, the controller 1531 of the server 101 outputs a contents reproduction instruction to the reproduction unit 1507 of the server 101 (S1221). The reproduction unit 1507 of the server 101 reproduces the selected contents, and transmits reproduced video data to the display apparatus 103a (S1223). In this example, the video data includes sound data that is synchronized with the video. However, the sound data may not be included. The video data and sound data may be transmitted, separately. Or, sound data without the video data may be transmitted.

The controller 1631 of the display apparatus 103a outputs a display instruction to the display unit 1601 of the display apparatus 103a (S1225). The display unit 1601 of the display apparatus 103a displays the contents (S1227). Specifically, the display unit 1601 of the display apparatus 103a receives the video data from the reproduction unit 1507 of the server 101, and displays the video data (S1229). Thus, the watching and listening by the user begin.

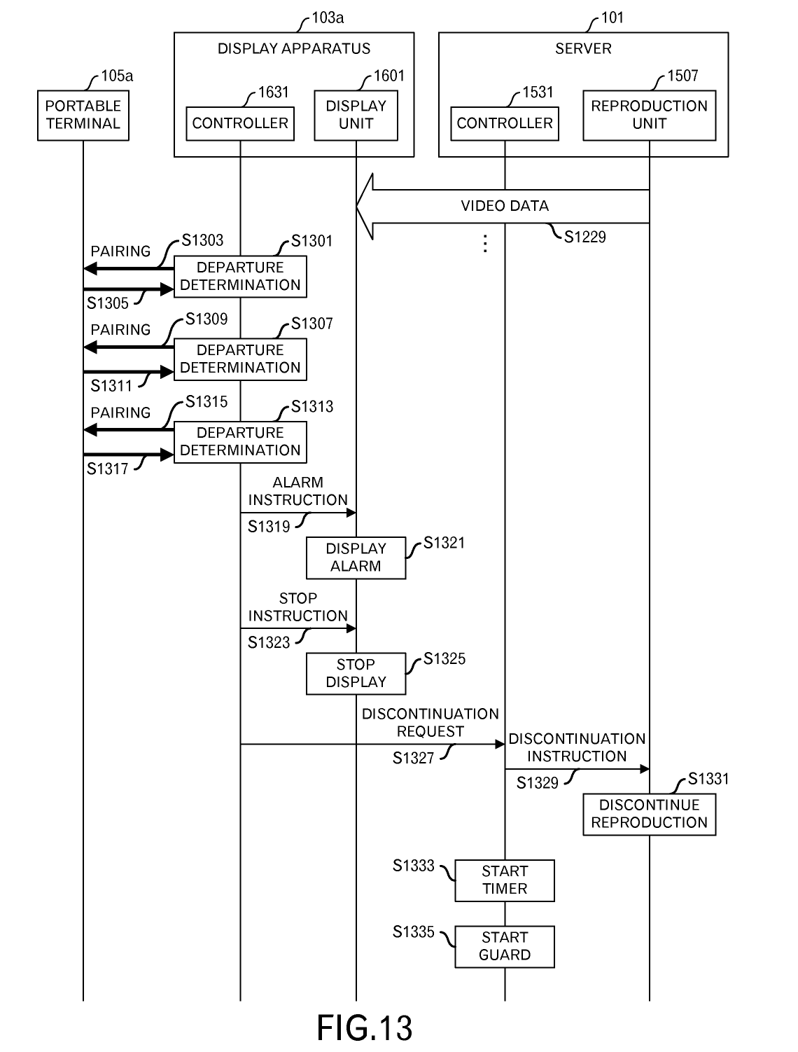

Next, a flow from the timing of the contents display to the timing of discontinuation of the contents reproduction will be explained using FIG. 13. FIG. 13 illustrates a data flow among the portable terminal 105a, display apparatus 103a and server 101 and a main processing. As for the display apparatus 103a, similarly to FIG. 12, a process by the controller 1631 and a process by the display unit 1601 are illustrated. As for the server 101, similarly to FIG. 12, a process by the controller 1531 and a process by the reproduction unit 1507 are illustrated.

While the display unit 1601 of the display apparatus 103a continuously displays the video data (S1229), the controller 1631 of the display apparatus 103a repeats a processing for determining whether or not the portable terminal 105a goes out of the communication area 203 (hereinafter, referred to “departure determination”) (S1301, S1307 and S1313). Specifically, the departure determination includes pairing by the near field communication. In other words, the controller 1631 transmits the radio wave signal to search the portable terminal (S1303, S1309 and S1315), and receives the radio wave signal that represents a response returned from the portable terminal 105a (S1305, S1311 and S1317). In this example, at the S1305 and S1311, the radio wave whose strength level is level 2 or stronger is received, and it is determined that the portable terminal 105a does not go out of the communication area 203a. At the S1317, the controller 1631 receives the radio wave whose strength level is level 1, and determines that the portable terminal 105a goes out of the communication area 203a.

When it is determined that the portable terminal 105a goes out of the communication area 203a, the controller 1631 of the display apparatus 103a outputs an instruction to display an alarm to the display unit 1601 of the display apparatus 103a (S1319). In response to this instruction, the display unit 1601 of the display apparatus 103a displays the aforementioned alarm (S1321). When a predetermined time elapsed since the display of the alarm, the controller 1631 of the display apparatus 103a outputs an instruction to stop the display of the contents to the display unit 1601 of the display apparatus 103a (S1323). In response to this instruction, the display unit 1601 of the display apparatus 103a stops the display of the contents (S1325). Furthermore, the controller 1631 of the display apparatus 103a transmits a request to discontinue the reproduction of the contents to the server 101 (S1327).

When the server 101 receives the discontinuation request, the controller 1531 of the server 101 outputs an instruction to discontinue the reproduction of the contents to the reproduction unit 1507 of the server 101 (S1329). In response to this instruction, the reproduction unit 1507 of the server 101 discontinues the reproduction of the contents (S1331). Moreover, the controller 1531 of the server 101 begins the operation of the timer (S1333). The timer measures the time of the discontinuation. The controller 1531 of the server 101 starts guard of the discontinued contents (S1335). Specifically, the server 101 prevents from deleting the source data of the contents. Moreover, the server 101 prevents from ejecting a medium (e.g. DVD) storing the source data of the contents.

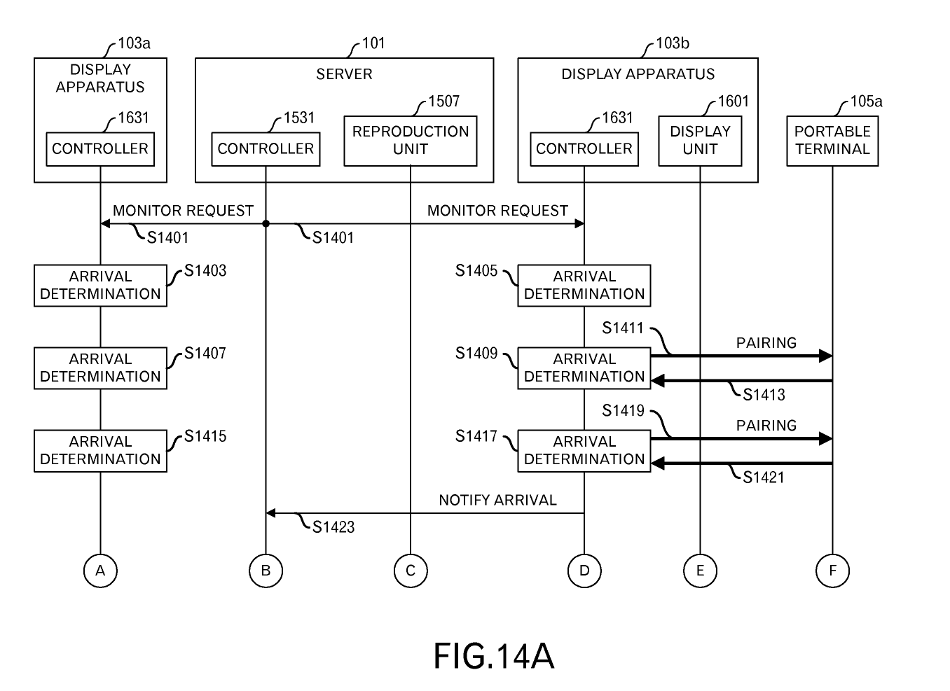

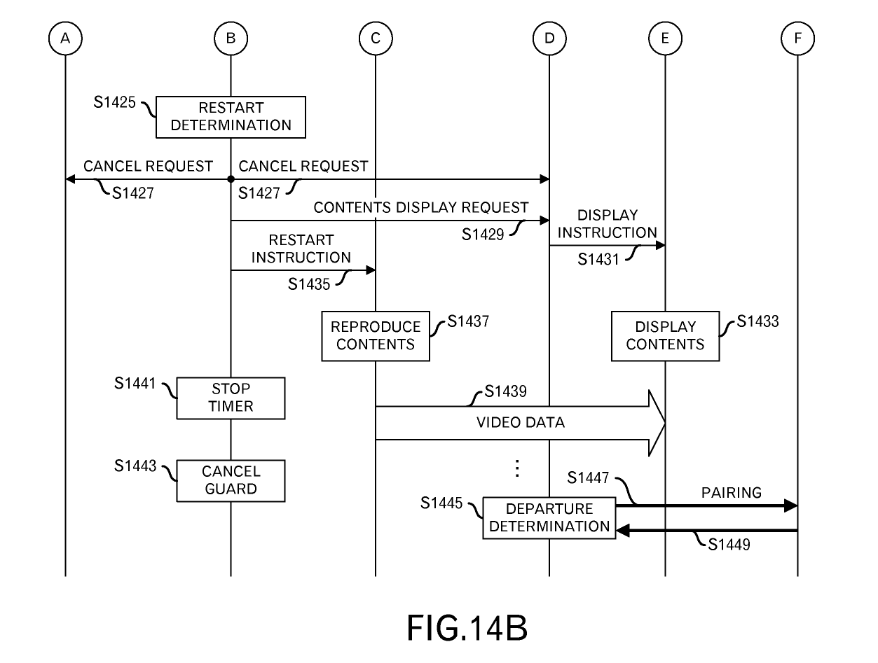

Furthermore, a flow from the timing of discontinuing the contents reproduction to the timing of restarting the display of the contents will be explained by using FIGS. 14A and 14B. FIGS. 14A and 14B illustrate a data flow among the display apparatus 103a, server 101, display apparatus 103b and the portable terminal 105a and a main processing. As for the display apparatus 103a, a process by the controller 1631 is illustrated. As for the server 101, similarly to FIGS. 12 and 13, a process by the controller 1531 and a process by a reproduction unit 1507 are illustrated. As for the display apparatus 103b, a process by the controller 1631 and a process by the display unit 1601 are illustrated.

The process by the controller 1631 of the display apparatus 103a continues from FIG. 14A to FIG. 14B through terminal A. The process by the controller 1531 of the server 101 continues from FIG. 14A to FIG. 14B through terminal B. The process by the reproduction unit 1507 of the server 101 continues from FIG. 14A to FIG. 14B through terminal C. The process by the controller 1631 of the display apparatus 103b continues from FIG. 14A to FIG. 14B through terminal D. The process by the display unit 1601 of the display apparatus 103b continues from FIG. 14A to FIG. 14B through terminal E. The process by the portable terminal 105a continues from FIG. 14A to FIG. 14B through terminal F.

The controller 1531 of the server 101 transmits a request to monitor the portable terminal 105 to the display apparatuses 103 (in this example, display apparatus 103a and display apparatus 103b) included in the contents reproduction system (S1401).

When the display apparatus 103 receives the request to monitor the portable terminal 105, the display apparatus 103 repeats a processing for determining whether or not the portable terminal 105 goes into the communication area 203 (hereinafter, referred to “arrival determination”) (S1403, S1407 and S1415). In this example, the display apparatus 103a repeats the arrival determination (S1403, S1407 and S1415). The display apparatus 103b repeats the arrival determination (S1405, S1409 and S1417). Specifically, the arrival determination includes pairing by the near field communication. The display apparatus 103 transmits a radio wave signal to search the portable terminal 105 (S1411 and S1419), and receives a radio wave signal representing a response from the portable terminal 105 (S1413 and S1421). In this example, in the arrival determination (S1403, S1407 and S1415) of the display apparatus 103a, there is no portable terminal 105 that will receive the radio wave signal for the search, so FIG. 14A does not depicts this signal. Moreover, also in the arrival determination (S1405) by the display apparatus 103b, there is no portable terminal 105 that will receive the radio wave signal for the search, so no signal is depicted.

On the other hand, in the arrival determination at S1409 and S1417, the portable terminal 105a receives the radio wave signal for the search. Then, the portable terminal 105a returns a radio wave signal representing the response (S1413 and S1421). At the S1413, the controller 1631 of the display apparatus 103b receives the radio wave whose strength level is level 1, and determines that the portable terminal 105a does not come into the communication area 203b. At the S1421, the controller 1631 of the display apparatus 103b receives the radio wave whose strength level is level 2, and determines that the portable terminal 105a comes into the communication area 203b.

When it is determined that the portable terminal 105a comes into the communication area 203b, the controller 1631 of the display apparatus 103b transmits notification of the arrival to the controller 1531 of the server 101 (S1423). The notification of the arrival includes an identifier of the portable terminal 105 that comes into the communication area 203 and the level of the radio wave that was received.

When the server 101 receives the notification of the arrival, the controller 1531 of the server 101 performs a processing for determining whether or not the restart of the contents reproduction is performed (hereinafter, referred to “restart determination”) (S1425). When the identifier (i.e. ID) of the portable terminal 105, which is included in the notification of the arrival, is identical to an ID of the portable terminal 105 that is associated with the discontinued contents, it is determined that the reproduction of the contents is restarted. Moreover, the controller 1531 identifies a display apparatus 103 that is a transmission source of the notification of the arrival. This display apparatus 103 is a transmission destination of the video data. In this example, the display apparatus 103b is identified.

When the notification of the arrival, which includes the ID of the portable terminal 105, which is associated with the discontinued contents, is transmitted from plural display apparatuses 103, the display apparatus 103 that is the transmission source of the notification of the arrival, which includes the highest level of the radio wave, is identified.

The controller 1531 of the server 101 transmits a request to cancel the monitor to the display apparatuses 103 (in this example, the display apparatus 103a and display apparatus 103b) included in the contents reproduction system (S1427). When the display apparatus 103 receives the request to cancel the monitor, the controller 1631 of the display apparatus 103 terminates the repeat of the arrival determination.

The controller 1531 of the server 101 transmits a contents display request to the identified display apparatus 103b (S1429).

When the display apparatus 103b receives the contents display request, the controller 1631 of the display apparatus 103b outputs a display instruction to the display unit 1601 of the display apparatus 103b (S1431). In response to this instruction, the display unit 1601 of the display apparatus 103b starts the display of the contents (S1433). The display unit 1601 of the display apparatus 103b receives the video data transmitted from the server 101, and becomes a state to display the video data.

Furthermore, the controller 1531 of the server 101 outputs an instruction to restart the contents reproduction to the reproduction unit 1507 of the server 101 (S1435). In response to this instruction, the reproduction unit 1507 of the server 101 restarts the discontinued reproduction of the contents (S1437). The reproduction unit 1507 of the server 101 transmits the video data to the display unit 1601 of the display apparatus 103b (S1439).

The controller 1531 of the server 101 stops the timer (S1441), and cancels the aforementioned guard (S1443). The controller 1631 of the display apparatus 103b starts the departure determination as described above (S1445).

As described above, the controller 1631 of the display apparatus 103b transmits a radio wave signal for the search (S1447), and receives a radio wave signal representing the response from the portable terminal 105a (S1449).

Next, module configurations of the server 101, display apparatus 103 and portable terminal 105 will be explained.

FIG. 15 illustrates an example of a modular configuration of the server 101. The server 101 includes a disk device controller 1501, manager 1503, search unit 1505, reproduction unit 1507, operation input unit 1509, LAN communication unit 1511, controller 1531, timer 1551, storage unit 1553 and memory unit 1555.

The disk device controller 1501 is a device to read data from a medium that stores data of contents. The manager 1503 manages the data of the contents. For example, the manager 1503 performs an operation to delete source data of the contents. The search unit 1505 searches for the contents, and generates a contents list. The reproduction unit 1507 reproduces the contents. Specifically, the reproduction unit 1507 reproduces the contents from a designated reproduction timing. In the reproduction processing, the compressed source data of the contents is decompressed, and the video data and sound data are generated, for example. The operation input unit 1509 accepts an operation from the user.

The LAN communication unit 1511 performs communication using LAN. The LAN communication unit 1511 includes a receiver 1513 and transmitter 1515. The receiver 1513 receives data (e.g. request) from an opposite device. The transmitter 1515 transmits data (e.g. video data) to an opposite device.

The controller 1531 performs control relating to cooperation in the contents reproduction system. The controller 1531 has a receiver 1533, instruction unit 1535 and determination unit 1537. The receiver 1533 accepts a request from an opposite device through the receiver 1513. The instruction unit 1535 instructs modules in the server 101. The determination unit 1537 performs determination relating to cooperation in the contents reproduction system.

The timer 1551 measures time (e.g. time while the contents reproduction is discontinued.). The storage unit 1553 has an area for storing data to be held continuously (e.g. contents management data). The memory unit 1555 has an area for storing a temporal data (e.g. the notification of the arrival).

Next, an example of the modular configuration of the display apparatus 103 will be explained by using FIG. 16. The display apparatus 103 includes a display unit 1601, operation input unit 1603, amplifier 1605, speaker 1607, LAN communication unit 1611, controller 1631, near-field communication unit 1651, storage unit 1653 and memory unit 1655.

The display unit 1601 displays various kinds of screens and video data. The operation input unit 1603 accepts operations from the user. The amplifier 1605 amplifies sound data. The speaker 1607 outputs sounds caused by the amplified sound data.

The LAN communication unit 1611 performs communication via LAN. The LAN communication unit 1611 has a receiver 1613 and transmitter 1615. The receiver 1613 receives data (e.g. video data) from an opposite device. The transmitter 1615 transmits data (e.g. request) to an opposite device.

The controller 1631 performs control relating to cooperation in the contents reproduction system. The controller 1631 has a receiver 1633, instruction unit 1635 and determination unit 1637. The receiver 1633 accepts a request from an opposite device through the receiver 1613. The instruction unit 1635 instructs modules in the display apparatus 103. The determination unit 1637 performs determination relating to the cooperation in the contents reproduction system.

The near-field communication unit 1651 performs the near-field communication. The near-field communication unit 1651 also performs an operation for pairing. The storage unit 1653 has an area for storing data (e.g. data of the portable terminal) that is continuously saved. The memory unit 1655 has an area for storing temporal data.

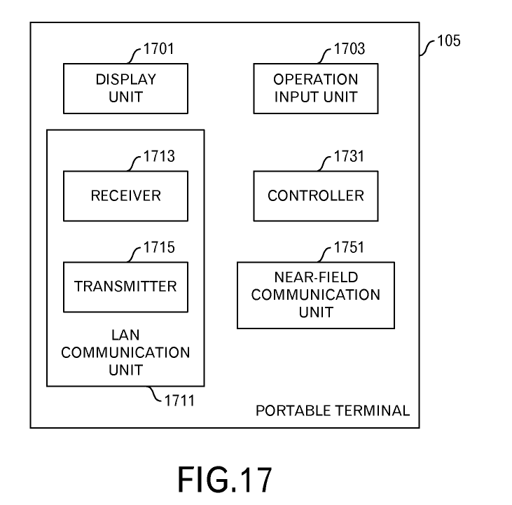

Furthermore, an example of the modular configuration of the portable terminal 105 will be explained by using FIG. 17. The portable terminal 105 includes a display unit 1701, operation input unit 1703, LAN communication unit 1711, controller 1731 and near-field communication unit 1751.

The display unit 1701 displays a screen such as operational screen. The operation input unit 1703 accepts operations from the user.

The LAN communication unit 1711 performs communication via LAN. The LAN communication unit 1711 has a receiver 1713 and transmitter 1715. The receiver 1713 receives data (e.g. request) from an opposite device. The transmitter 1715 transmits data (e.g. request) to an opposite device. The controller 1731 performs control relating to cooperation in the contents reproduction system. The near-field communication unit 1751 performs near field communication. The near-field communication unit 1751 also performs an operation to respond to the pairing.

Next, along with the aforementioned sequences, a processing flow of the server 101 and display apparatus 103 will be explained.

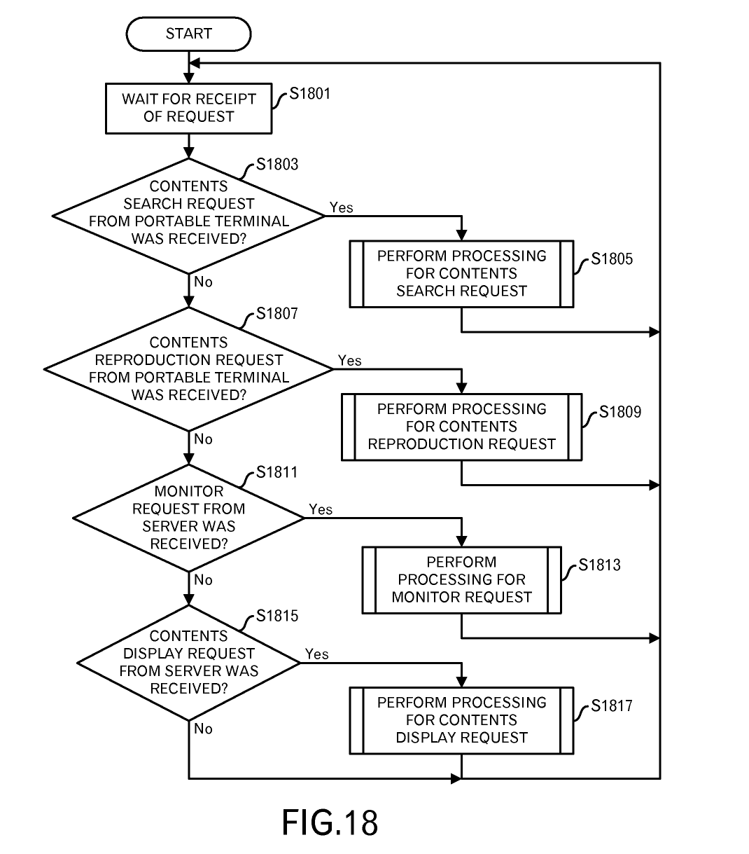

FIG. 18 illustrates an example of a processing flow in the controller 1631 of the display apparatus 103. The receiver 1633 waits for receipt of a request from the server 101 or portable terminal 105 (S1801). When receiving the request, the receiver 1633 determines whether or not the received request is a contents search request from the portable terminal 105 (S1803). When it is determined that the received request is not the contents search request from the portable terminal 105, the processing shifts to a processing of S1807. On the other hand, when it is determined that the received request is the contents search request from the portable terminal 105, the controller 1631 performs a processing for the contents search request (S1805).

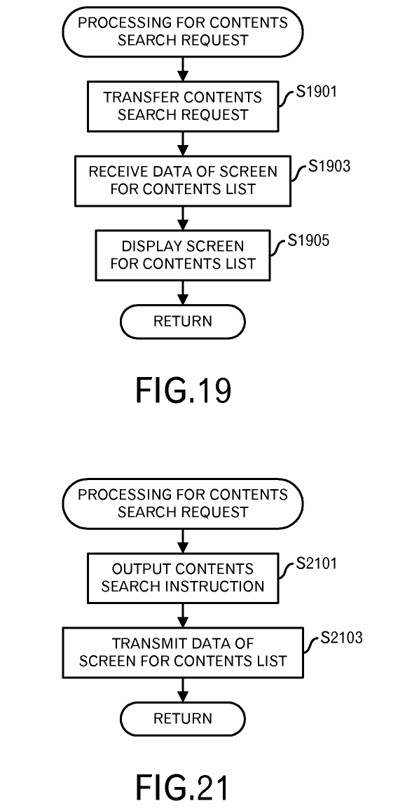

FIG. 19 illustrates an example of a processing flow of the processing for the contents search request in the display apparatus 103. The transmitter 1615 transfers the contents search request (S1901). The contents search request may include a search condition.

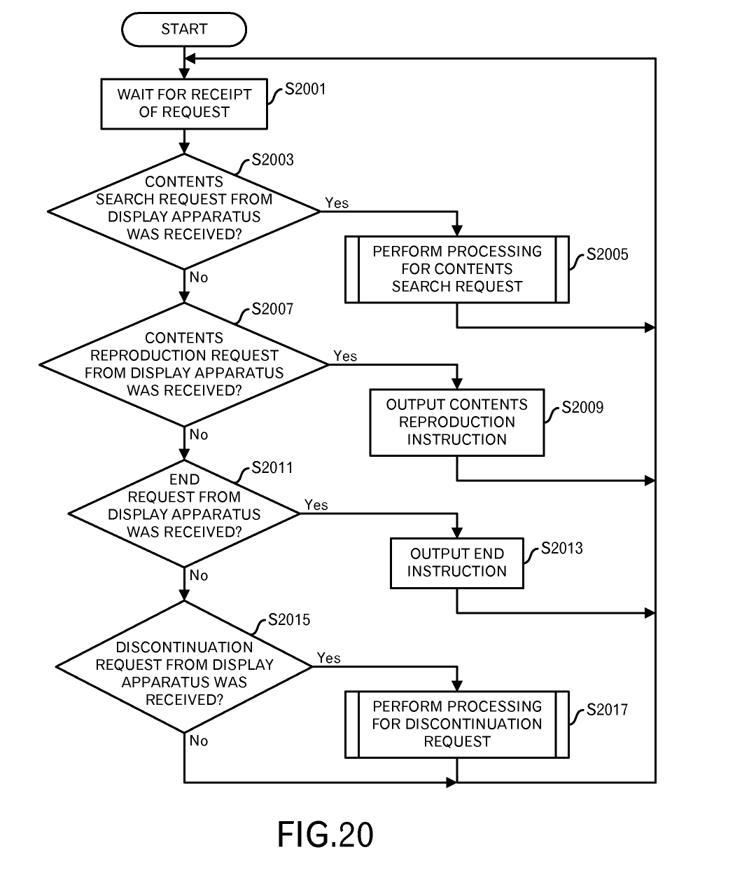

Next, an explanation of the server 101 will be made. FIG. 20 illustrates an example of a processing flow in the controller 1531 of the server 101. The receiver 1513 waits for receipt of a request from the display apparatus 103 (S2001). When receiving the request, the receiver 1533 determines whether or not the received request is the contents search request from the display apparatus 103 (S2003). When it is determined that the received request is not the contents search request from the display apparatus 103, the processing shifts to a processing of S2007. On the other hand, when it is determined that the received request is the contents search request from the display apparatus 103, the controller 1531 performs a processing for the contents search request (S2005).

FIG. 21 illustrates an example of a processing flow of the processing for the contents search request in the server 101. The instruction unit 1535 outputs a contents search instruction to the search unit 1505 (S2101). In response to this instruction, the search unit 1505 reads data (e.g. title, playback time and the like) concerning contents stored in the medium from the disk device controller 1501, and generates data of a screen for the contents list. This processing corresponds the contents search (S1207) illustrated in FIG. 12. By the instruction of the controller 1531, the transmitter 1515 transmits the generated data of the screen representing the contents list to the display apparatus 103 (S2103).

Returning to the explanation of the processing in FIG. 19, the receiver 1613 of the display apparatus 103 receives data of the screen for the contents list (S1903), and the display unit 1601 of the display apparatus 103 displays the screen for the contents list (S1905). This processing corresponds to the display of the contents list (S1215) illustrated in FIG. 12. When the processing for the contents search request ends, the processing returns to the processing of the S1801 illustrated in FIG. 18.

Thus, the contents list is displayed by the display unit 1601 of the display apparatus 103. The aforementioned processing corresponds to the sequence up to the S1215 illustrated in FIG. 12. Furthermore, the explanation of the processing concerning the contents reproduction will continue.

Returning to the explanation of the processing illustrated in FIG. 18, the receiver 1633 of the display apparatus 103 determines whether or the received request is the contents reproduction request from the portable terminal 105 (S1807). When it is determined that the received request is not the contents reproduction request from the portable terminal 105, the processing shifts to a processing of S1811. On the other hand, when it is determined that the received request is the contents reproduction request from the portable terminal 105, the controller 1631 of the display apparatus 103 performs a processing for the contents reproduction request (S1809).

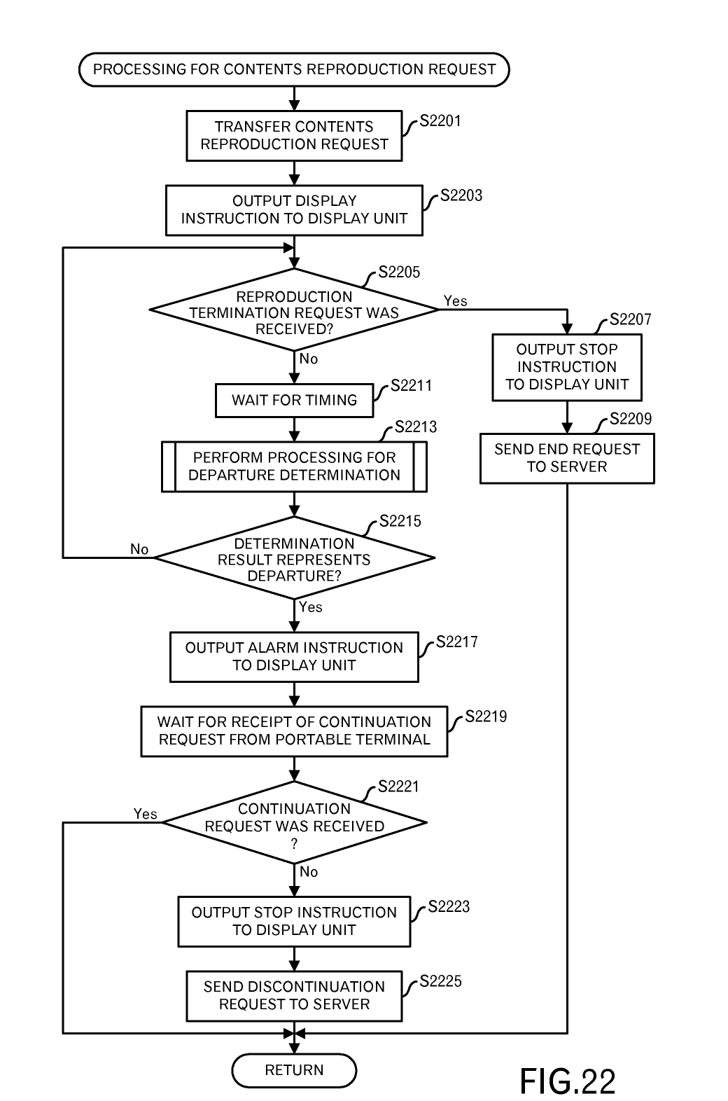

FIG. 22 illustrates an example of a processing flow of the processing for the contents reproduction request. By the instruction of the controller 1631 of the display apparatus 103, the transmitter 1615 transfers the contents reproduction request to the server 101 (S2201). The contents reproduction request includes information to identify the contents to be reproduced.

Returning to the processing in FIG. 20, the receiver 1533 of the server 101 determines whether or not the received request is the contents reproduction request from the display apparatus 103 (S2007). When it is determined that the received request is not the contents reproduction request from the display apparatus 103, the processing shifts to a processing of S2011. On the other hand, when it is determined that the received request is the contents reproduction request from the display apparatus 103, the instruction unit 1535 outputs a contents reproduction instruction to the reproduction unit 1507 (S2009). In response to this instruction, the reproduction unit 1507 sequentially reads and decodes the source data of the contents, which is stored in the medium, from the disk device controller 1501, and generates video data. Then, the server 101 sequentially transmits the video data to the requesting source. This processing corresponds to the contents reproduction (S1223) illustrated in FIG. 12.

Returning to the explanation of the processing in FIG. 22, the instruction unit 1635 of the display apparatus 103 outputs a display instruction to the display unit 1601 (S2203). The display unit 1601 displays the video data that is sequentially received through the receiver 1613. When the video data includes the sound data, the amplifier 1605 amplifies the sound data, and outputs sounds to the speaker 1607. This processing corresponds to the contents display (S1227) illustrated in FIG. 12.

With the processing up to this stage, the contents are displayed on the display unit 1601 of the display apparatus 103. The aforementioned processing corresponds to the sequence up to the S1229 illustrated in FIG. 12. Furthermore, the processing concerning the contents reproduction will continue.

When the end of the reproduction is instructed from the portable terminal 105 during the reproduction, a reproduction termination request is transmitted from the portable terminal 105, and the contents reproduction in the server 101 is terminated, and the display of the contents ends in the display apparatus 103. In the following, a processing for ending will be explained.

The receiver 1633 of the display apparatus 103 determines whether or not the reproduction termination request was received (S2205). When it is determined that the reproduction termination request is not received, the processing shifts to a processing of S2211. On the other hand, when it is determined that the reproduction termination request was received, the instruction unit 1635 outputs a stop instruction to the display unit 1601 (S2207). In response to this instruction, the display unit 1601 stops the display of the contents. When the video data includes the sound data, the output of the sounds is stopped. The transmitter 1615 transmits an end request to end the reproduction of the contents to the server 101 (S2209).

Returning to the processing in FIG. 20, the receiver 1533 of the server 101 determines whether or not the received request is an end request from the display apparatus 103 (S2011). When it is determined that the received request is not the end request from the display apparatus 103, the processing shifts to the processing of S2015. On the other hand, when it is determined that the received request is the end request from the display apparatus 103, the instruction unit 1535 outputs an end instruction to the reproduction unit 1507 (S2013). According to this instruction, the reproduction unit 1507 ends the reproduction of the contents.

Next, a processing for the discontinuation will be explained.

Returning to the processing in FIG. 22, the determination unit 1637 of the display apparatus 103 waits for receipt of a timing for a departure determination processing (S2211). For example, the determination unit 1637 waits until the predetermined period elapsed since the previous departure determination processing. At the timing for the departure determination, the determination unit 1637 performs the departure determination processing (S2213). This processing corresponds to the departure determination (S1301, S1307 and S1313) illustrated in FIG. 13.

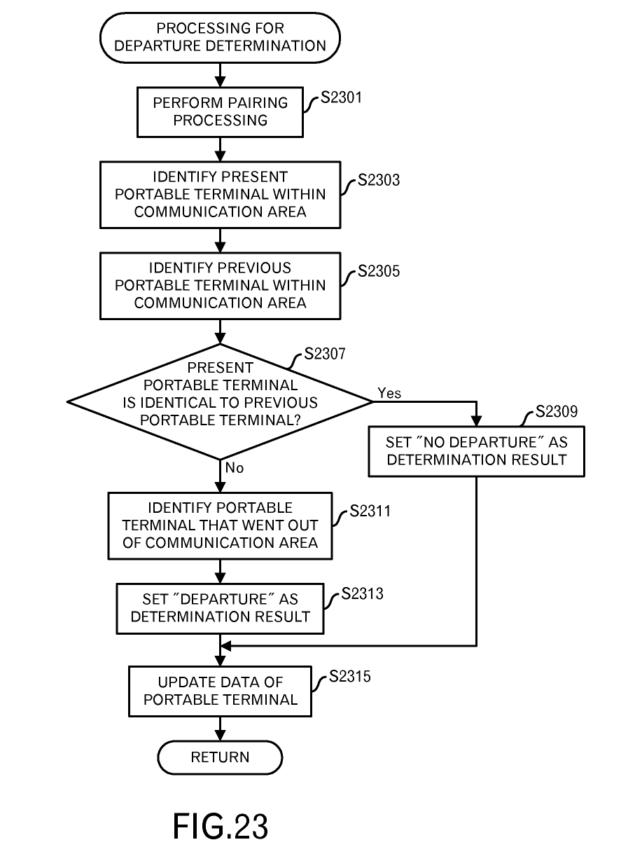

FIG. 23 illustrates an example of a processing flow of the departure determination processing. The determination unit 1637 causes the near-field communication unit 1651 to perform a pairing processing (S2301). In the pairing processing, the near-field communication unit 1651 transmits a radio wave signal for the search, and receives a radio wave signal representing a response from the portable terminal 105. The radio wave signal representing the response includes an ID of the responding portable terminal 105.

The determination unit 1637 determines a present portable terminal within the communication area (S2303). The present portable terminal within the communication area is a portable terminal 105 that is determined as being in the communication area 203 by the current pairing. Specifically, an ID of the portable terminal 105, which is included in the radio wave signal whose strength level is level 2 or higher among the radio wave signals representing the response, is identified.

Furthermore, the determination unit 1637 identifies a previous portable terminal within the communication area (S2305). The previous portable terminal within the communication area is a portable terminal 105 that is determined as being in the communication area 203 by the previous pairing. Specifically, it is determined based on data of the portable terminal, which is stored in the storage unit 1653.

Then, the determination unit 1637 determines whether or not the previous portable terminal within the communication area is identical to the present portable terminal within the communication area (S2307). When it is determined that the previous portable terminal within the communication area is identical to the present portable terminal within the communication area, the determination unit 1637 sets “no departure” as the determination result (S2309). On the other hand, when it is determined that the previous portable terminal within the communication area is not identical to the present portable terminal within the communication area, the determination unit 1637 identifies a portable terminal 105 that went out of the communication area 203 (S2311). Specifically, the previous portable terminal within the communication area, which is not identical to the present portable terminal within the communication area, is the portable terminal 105 that went out of the communication area 203. Then, the determination unit 1637 sets “departure” as the determination result (S2313).

Even in any case of the determination result, the determination unit 1637 updates data of the portable terminal based on this present response (S2315). The processing returns to the processing of S2215 in FIG. 22.

Returning to the explanation of the processing in FIG. 22, the controller 1631 branches off the processing according to the determination result (S2215). When the determination result is “no departure”, the processing returns to the processing of S2205. On the other hand, when the determination result is “departure”, the instruction unit 1635 outputs an instruction to display an alarm to the display unit 1601 (S2217). The display unit 1601 displays the alarm to the effect that the reproduction and display of the contents will be discontinued. This processing corresponds to the alarm display (S1321) illustrated in FIG. 13.

The receiver 1613 waits for receipt of a continuation request from the portable terminal 105 until the predetermined period elapsed (S2219). The receiver 1633 determines whether or not a continuation request was received from the portable terminal 105 (S2221). When it is determined that the continuation request was received from the portable terminal 105, the processing for the contents reproduction request ends. Therefore, the reproduction and display of the contents continues as it is hereinafter. The video data may be received by the portable terminal 105 and continue the display of the video data in response to an operation from the user for the portable terminal 105.

On the other hand, when it is determined that the continuation request is not received from the portable terminal 105, the instruction unit 1635 outputs an instruction to stop the display of the contents to the display unit 1601 (S2223). In response to this instruction, the display unit 1601 stops the display of the contents. S2223 corresponds to the display stop (S1325) illustrated in FIG. 13. Furthermore, the transmitter 1615 transmits a discontinuation request to discontinue the reproduction of the contents to the server 101 (S2225).

Returning to the explanation of the processing in FIG. 20, the receiver 1533 of the server 101 determines whether or not the received request is a discontinuation request from the display apparatus 103 (S2015). When it is determined that the received request is not the discontinuation request from the display apparatus 103, the processing returns to the processing of S2001. On the other hand, when it is determined that the received request is the discontinuation request from the display apparatus 103, the controller 1531 performs a processing for the discontinuation request (S2017).

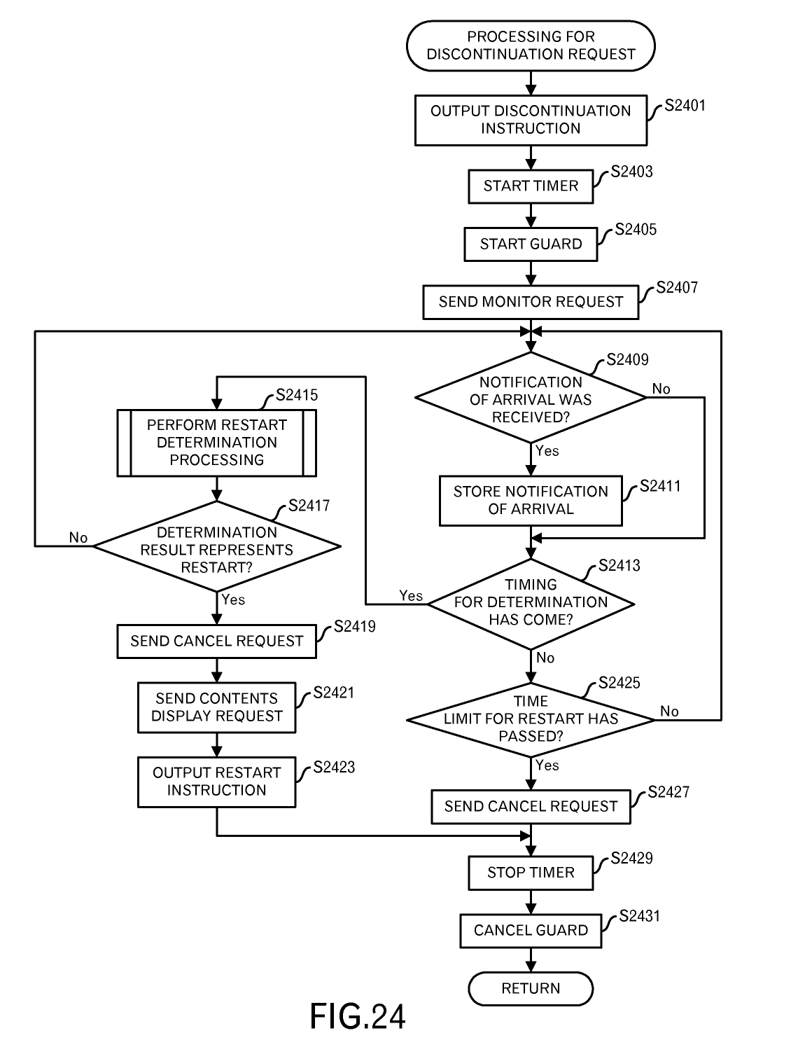

FIG. 24 illustrates an example of a processing flow of the processing for the discontinuation request. The instruction unit 1535 outputs an instruction to discontinue the reproduction of the contents to the reproduction unit 1507 (S2401). In response to this instruction, the reproduction unit 1507 discontinues the reproduction of the contents. This processing corresponds to the reproduction discontinuation (S1331) illustrated in FIG. 13.

The controller 1531 causes the timer 1551 to start the measurement of the discontinued period (S2403). The timer 1551 starts the measurement of the discontinued period. This processing corresponds to the timer start (S1333) illustrated in FIG. 13.

The controller 1531 causes the disk device controller 1501 and manager 1503 to start the guard (S2405). The disk device controller 1501 and manager 1503 start the guard. The disk device controller 1501 operates so as not to accept an instruction to eject the medium storing the source data of the contents for which the reproduction is discontinued. Or, even when the disk device controller 1501 accepts an instruction to eject the medium storing the contents for which the reproduction is discontinued, the operation to eject the medium is not carried out.

At this time, in response to the eject instruction, being in a guard state in which the medium is not ejected may be displayed.

The manager 1503 operates so as not to accept any instruction to delete the contents for which the reproduction is discontinued. Or, even when the manager 1503 accepts an instruction to delete the source data of the contents for which the reproduction is discontinued, the manager 1503 does not perform any operation to delete the contents. This processing corresponds to the guard start (S1335) illustrated in FIG. 13.

At this time, in response to a delete instruction, being in the guard state in which the source data of the contents is not deleted may be displayed. Thus, it is possible to prevent from erroneously deleting the contents in order to secure the capacity.

Thus, the reproduction and display of the contents are discontinued. The aforementioned processing corresponds to the sequence up to the S1335 illustrated in FIG. 13. Furthermore, a processing for the restart will continue.

As illustrated in FIG. 24, the transmitter 1515 of the server 101 transmits a monitor request to the display apparatuses 103 connected to the LAN (S2407).

Returning to the explanation of the processing in FIG. 18, the receiver 1633 of the display apparatus 103 determines whether or not the received request is a monitor request from the server 101 (S1811). When it is determined that the received request is not the monitor request from the server 101, the processing shifts to the processing of S1815. On the other hand, when it is determined that the received request is the monitor request from the server 101, the controller 1631 performs a processing for the monitor request (S1813).

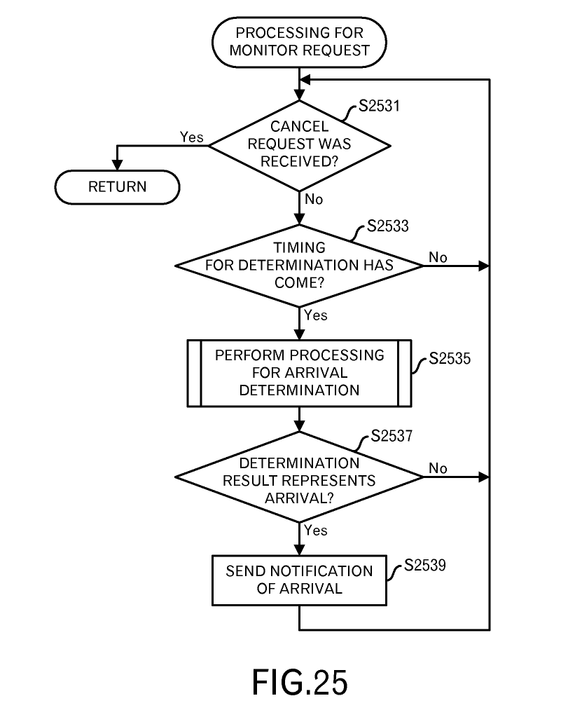

FIG. 25 illustrates an example of a processing flow of the processing for the monitor request. The receiver 1633 determines whether or not a cancel request is received by the receiver 1613 (S2531). When it is determined that the cancel request was received by the receiver 1613, the processing for the monitor request ends, and the processing returns to the processing of S1801 in FIG. 18.

When it is determined that the cancel request is not received by the receiver 1613, the determination unit 1637 determines whether or not a timing for executing the arrival determination has come. For example, when a predetermined time elapsed since the previous arrival determination processing, it is determined that the timing for executing the arrival determination has come. When it is determined that the timing for executing the arrival determination has not come, the processing returns to the processing of S2531. On the other hand, when the timing for executing the arrival determination has come, the determination unit 1637 performs the arrival determination processing (S2535).

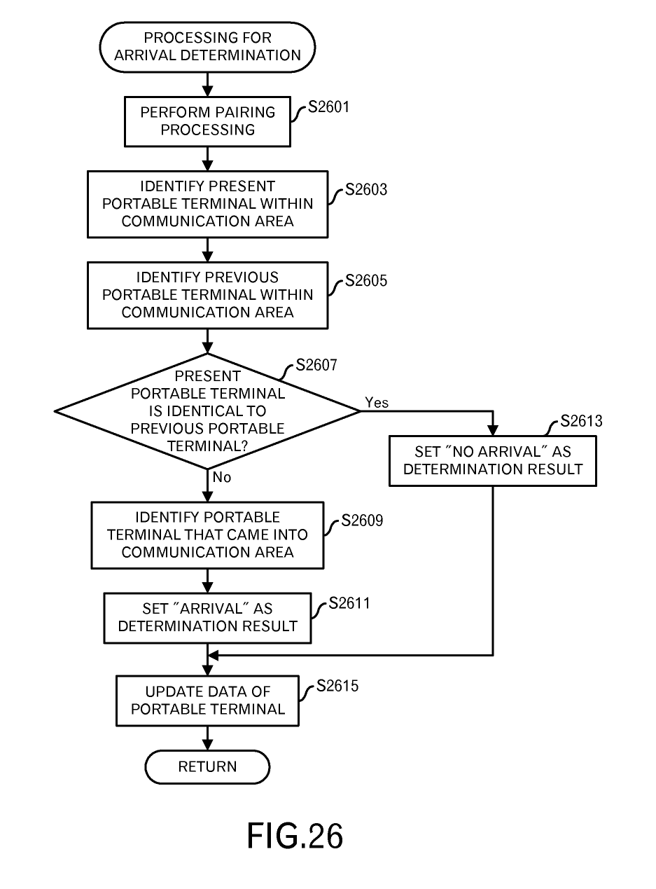

FIG. 26 illustrates an example of a processing flow of the arrival determination processing. This corresponds to the arrival determination illustrated in FIG. 14A (S1403, S1405, S1407, S1409, S1415 and S1417). The determination unit 1637 performs a pairing processing by the near-field communication unit 1651 (S2601). By the pairing processing, the near-field communication unit 1651 transmits a radio wave signal for the search, and receives a radio wave signal representing the response from the portable terminal 105. The radio wave signal representing the response includes an ID of the portable terminal 105 that responded to the transmitted radio wave signal from the display apparatus 103.

The determination unit 1637 identifies a present portable terminal within the communication area (S2603). The present portable terminal within the communication area is a portable terminal 105, which is determined as being in the communication area 203 by the current pairing. Specifically, an ID of the portable terminal 105, which is included in the received radio wave signal whose strength level is level 2 or higher among the radio wave signals representing the response is identified.

Furthermore, the determination unit 1637 identifies a previous portable terminal within the communication area (S2605). The previous portable terminal within the communication area is a portable terminal 105 that is determined as being in the communication area 203 by the previous pairing. Specifically, it is identified from the data of the portable terminal, which is stored in the storage unit 1653.

Then, the determination unit 1637 determines whether or not the present portable terminal within the communication area is identical to the previous portable terminal within the communication area (S2607). When it is determined that the present portable terminal within the communication area is not identical to the previous portable terminal within the communication area, the determination unit 1637 identifies a portable terminal that came into the communication area 203 (S2609). Specifically, the present portable terminal within the communication area, which is not identical to the previous portable terminal within the communication area, is the portable terminal that came into the communication area 203. Then, the determination unit 1637 sets “arrival” as the determination result (S2611).

On the other hand, when it is determined at the S2607 that the present portable terminal within the communication area is identical to the previous portable terminal within the communication area, the determination unit 1637 sets “no arrival” as the determination result (S2613). In any case of the determination result, the determination unit 1637 updates data of the portable terminal based on the response at this time (S2615). Then, the processing returns to the processing of S2537 illustrated in FIG. 25.

Returning to the explanation of the processing in FIG. 25, the controller 1631 branches off the processing based on the determination result (S2537). When the determination result is “no arrival”, the processing returns to the processing of S2531. On the other hand, when the determination result is “arrival”, the transmitter 1615 transmits arrival notification to the server 101 (S2539). The arrival notification includes the level of the radio wave and an ID of the portable terminal 105.

Returning to the explanation of the processing in FIG. 24, the receiver 1533 of the server 101 determines whether or not the arrival notification is received through the receiver 1513 (S2409). When it is determined that the arrival notification was received, the receiver 1533 stores the arrival notification into the memory unit 1555 (S2411) and, the processing shifts to a processing of S2413. When it is determined that the arrival notification is not received, the processing shifts to a processing of S2413. The determination unit 1537 determines whether or not the timing of the restart determination has come (S2413). For example, when a predetermined period elapsed since the previous restart determination processing, it is determined that the timing of the restart determination has come.

When it is determined that the timing of the restart determination has come, the determination unit 1537 performs the restart determination processing (S2415). This processing corresponds to the restart determination (S1425) illustrated in FIG. 14B.

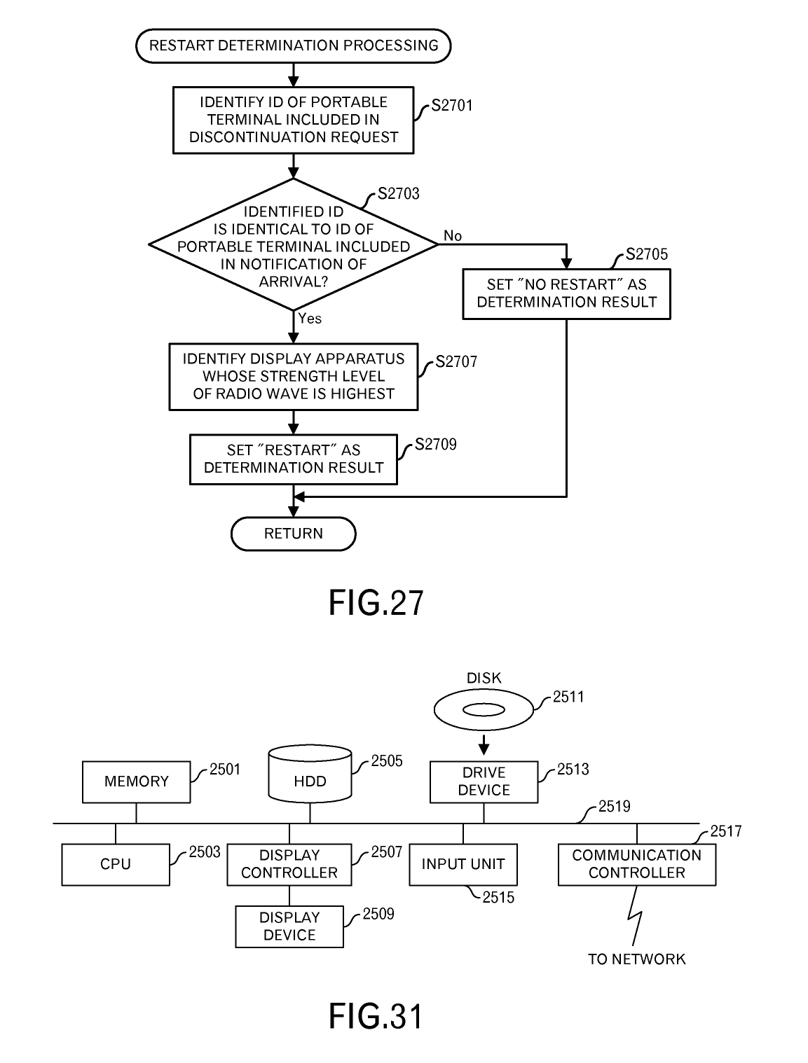

FIG. 27 illustrates an example of a processing flow of the restart determination processing. The determination unit 1537 identifies an ID of the portable terminal 105, which is included in the discontinuation request (S2701). The determination unit 1537 determines whether or not the ID of the portable terminal 105, which is included in the discontinuation request, is identical to the ID of the portable terminal 105, which is included in the arrival notification (S2703). When it is determined that the ID of the portable terminal 105, which is included in the discontinuation request, is not identical to the ID of the portable terminal 105, which is included in the arrival notification, the determination unit 1537 sets “no restart” as the determination result (S2705), and the restart determination processing ends.

On the other hand, when it is determined that the ID of the portable terminal 105, which is included in the discontinuation request, is identical to the ID of the portable terminal 105, which is included in the arrival notification, the determination unit 1537 identifies a display apparatus 103, which is the transmission source of the arrival notification having the highest level of the radio wave (S2707). When there is one arrival notification including the ID of the portable terminal 105, which is included in the discontinuation request, the display apparatus 103 that is the transmission source of that arrival notification is identified. The determination unit 1537 sets “restart” as the determination result (S2709), and the restart determination processing ends.

Thus, in a situation that the user who holds the portable terminal 105 approaches two or more display apparatuses 103, a display apparatus 103 that is presumed as being closest can be selected.

Returning to the explanation of the processing in FIG. 24, the controller 1531 branches off the processing based on the determination result (S2417). When the determination result is “no restart”, the processing returns to the processing of S2409. On the other hand, when the determination result is “restart”, the transmitter 1515 transmits a request to cancel the monitor to the display apparatuses 103 that are connected to the LAN (S2419). The response of the display apparatus 103 to this request is as explained at the S2531 in FIG. 25.

The transmitter 1515 transmits a contents display request to the display apparatus 103 identified at the S2707 illustrated in FIG. 27 (S2421).

Returning to the explanation of the processing in FIG. 18, the receiver 1633 of the display apparatus 103 determines whether or not the received request is the contents display request from the server 101 (S1815). When it is determined that the received request is not the contents display request from the server 101, the processing returns to the processing of S1801. On the other hand, when it is determined that the received request is the contents display request from the server 101, the controller 1631 performs the processing for the contents display request (S1817).

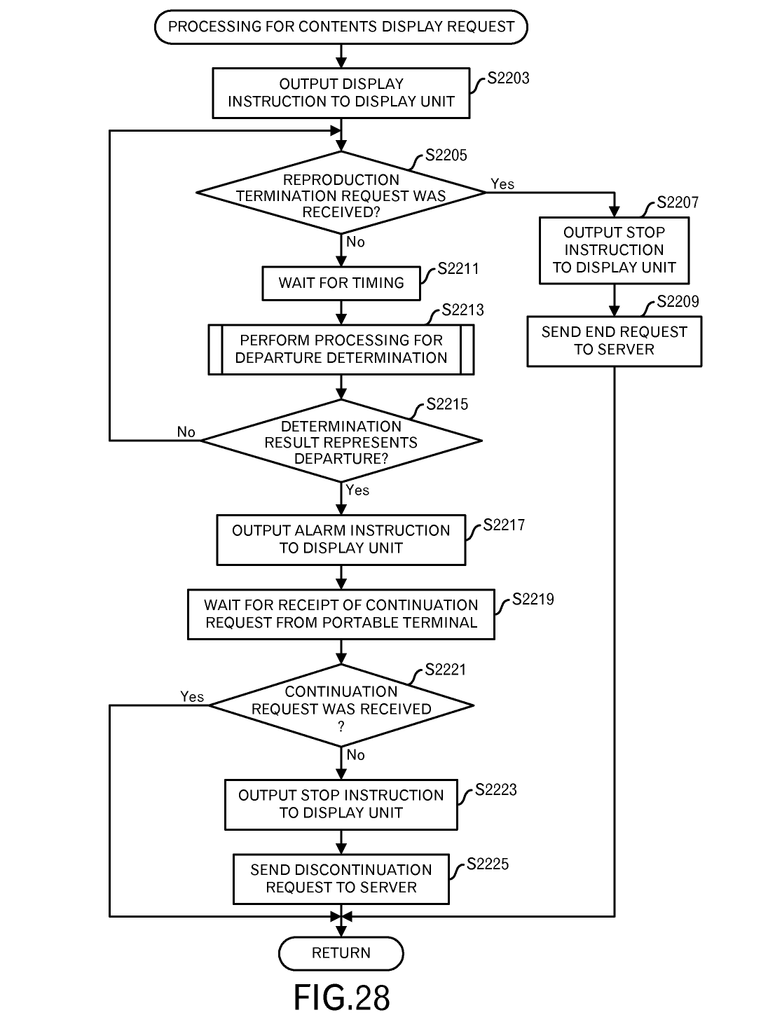

FIG. 28 illustrates an example of a processing flow of the processing for the contents display request. In this processing, the same processing from S2203 to S2225 in the processing flow of the processing for the contents reproduction request is performed.

Returning to the explanation of the processing in FIG. 24, the instruction unit 1535 of the server 101 outputs an instruction to restart the reproduction of the contents to the reproduction unit 1507 (S2423). The reproduction unit 1507 restarts the reproduction of the contents, which was discontinued. In other words, based on the contents management data stored in the storage unit 1553, the reproduction is restarted from the reproduced time.

The processing up to this stage corresponds to the sequence up to S1449 in FIG. 14B. When the time limit of the restart has passed, the monitor, timer and guard are cancelled by the display apparatus 103. In the following, a processing for that cancel will be explained.

As illustrated in FIG. 24, when it is determined at the S2413 that the timing for the restart determination has not come, the determination unit 1537 determines whether or not a time limit for the restart has passed (S2425). For example, when the discontinuation period measured by the timer 1551 exceeds a predetermined period, it is determined that the time limit for the restart has passed. When it is determined the time limit for the restart has not passed, the processing returns to the processing of S2409.

On the other hand, when it is determined that the restart limit has passed, the transmitter 1515 transmits a request to cancel the monitor to the display apparatuses 103 connected to the LAN (S2427). The controller 1531 stops the measurement by the timer 1551 (S2429). This processing corresponds to the timer stop (S1441) illustrated in FIG. 14B. The controller 1531 causes the disk device controller 1501 and manager 1503 to cancel the guard (S2431). This processing corresponds to the guard cancel (S1443) illustrated in FIG. 14B.

As a method for cancelling the discontinuation, the discontinuation may be cancelled in response to an instruction accepted by the operation input unit 1703 of the portable terminal 105. Moreover, the discontinuation may be cancelled in response to an instruction accepted by the operation input unit 1603 of the display apparatus 103.

Moreover, even in the state that the guard is performed, the guard maybe forcibly cancelled in response to the instruction from the user. In other words, the source data of the contents may be forcibly deleted, and the medium storing the source data of the contents may be forcibly ejected.

According to this embodiment, at the stage when the user who holds the portable terminal 105 approaches the display apparatus 103, both or either of the video reproduction and sound reproduction, which are discontinued, and both or either of the video output and sound output, which were stopped, are automatically restarted, and the watching and/or listening continues without any particular operation. Furthermore, the watching and/or listening can be made without any interval or returning to the beginning.

Furthermore, at the stage when the user who holds the portable terminal 105 leaves from a certain output device, it is possible to suppress wasteful reproduction and output.

Moreover, because of the guard, it is possible to avoid a situation that the source data of the contents or medium storing the source data disappears or a situation that the reproduction cannot be restarted.

In response to the instruction from the portable terminal 105, the departure determination may be stopped or restarted during the reproduction.

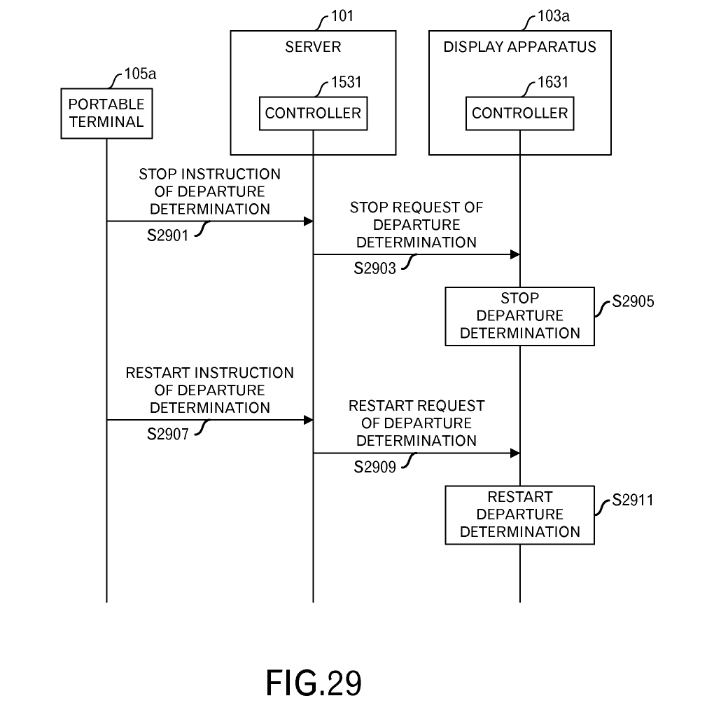

A sequence for stop and restart of the departure determination will be explained by using FIG. 29. While the controller 1631 of the display apparatus 103a is carrying out the departure determination, when a stop instruction of the departure determination is transmitted to the controller 1531 of the server 101 from the portable terminal 105a (S2901), the controller 1531 of the server 101 transmits a stop request of the departure determination to the controller 1631 of the display apparatus 103a (S2903). When receiving the stop request of the departure determination, the controller 1631 of the display apparatus 103a stops the departure determination (S2905).

While the controller 1631 of the display apparatus 103a stops the departure determination, when a restart request of the departure determination is transmitted to the controller 1531 of the server 101 from the portable terminal 105a (S2907), the controller 1531 of the server 101 transmits a restart request of the departure determination to the controller 1631 of the display apparatus 103a. When receiving the restart request of the departure determination, the controller 1631 of the display apparatus 103a restarts the departure determination (S2911).

Moreover, when it is determined, by using an accelerometer or magnetic field sensor, which is included in the portable terminal 105, that the portable terminal 105 is at rest for a predetermined time or more after the reproduction start, the departure determination maybe stopped. Moreover, when the portable terminal 105 gets out of the rest state, the departure determination may be restarted.

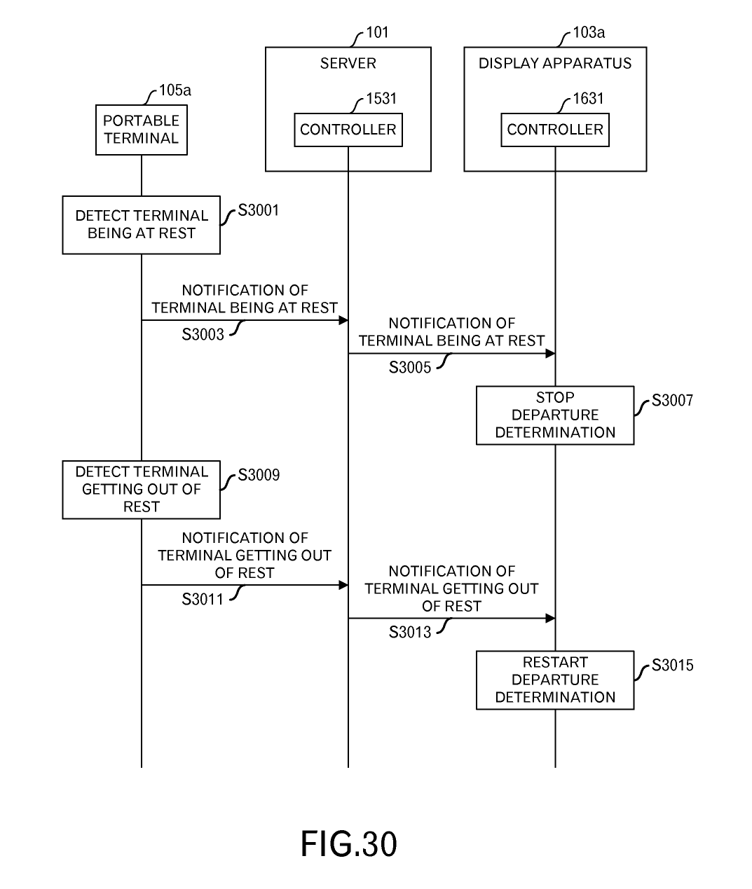

A sequence for stop and restart of the departure determination will be explained by using FIG. 30. While the controller 1631 of the display apparatus 103a is carrying out the departure determination, when the portable terminal 105a detects this terminal is at rest (S3001), notification that this terminal is at rest is transmitted to the controller 1531 of the server 101 (S3003). The controller 1531 of the server 101 transfers the notification that this terminal is at rest to the controller 1631 of the display apparatus 103a (S3005). When receiving the notification of the terminal being at rest, the controller 1631 of the display apparatus 103a stops the departure determination (S3007).

While the controller 1631 of the display apparatus 103a stops the departure determination, when the portable terminal 105a detects that this terminal gets out of the rest (S3009), notification that the terminal gets out of the rest is transmitted to the controller 1531 of the server 101 from the portable terminal 105a (S3011). The controller 1531 of the server 101 transfers the notification that the terminal gets out of the rest to the controller 1631 of the display apparatus 103a (S3013). When receiving the notification of the terminal getting out of the rest, the controller 1631 of the display apparatus 103a restarts the departure determination (S3015).

Although the embodiments of this invention were explained, this invention is not limited to those embodiments. For example, the aforementioned functional block configurations may not correspond to program module configurations.

Moreover, the aforementioned memory area configuration is a mere example, and may be changed. Furthermore, as for the processing flow, as long as the processing results do not change, the turns of the steps maybe exchanged, and plural steps may be executed in parallel.

In addition, the aforementioned server 101 and display apparatus 103 maybe computer devices as illustrated in FIG. 31. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 31. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

An output method relating to the embodiments includes: (A) receiving, from an output apparatus of plural output apparatuses, notification that represents that a radio wave from a portable apparatus was received; and (B) first causing the output apparatus that received the radio wave to restart both or either of an image output and a sound output, which were stopped.

Thus, when the user who holds the portable apparatus approaches the output apparatus, it is possible to automatically restart both or either of the image (e.g. video) output and sound output, which were stopped. Accordingly, the user can continuously watch and/or listen the image and/or sound without any particular operation.

Furthermore, the aforementioned output method may further include: selecting an output apparatus that received the radio wave whose strength is greater from among two or more output apparatuses that received the radio wave.

With this configuration, in a situation that the user who holds the portable apparatus approaches two or more output apparatuses, it is possible to select one output apparatus that is presumed as being closer.

Moreover, the aforementioned output method may further include: upon detecting that strength of a radio wave received from the portable apparatus by another output apparatus that is outputting both or either of an image and a sound does not reach predetermined strength, second causing the another output apparatus to stop both or either of the image and the sound; and discontinuing reproduction of output data relating to both or either of the image and the sound.

According to this configuration, when the user who holds the portable apparatus leaves from the output apparatus, it is possible to suppress wasteful reproduction and output operation.

Furthermore, the aforementioned output method may further include: at the first causing, restarting the reproduction that was discontinued.

Thus, when the user who holds the portable apparatus approaches the output apparatus, it is possible to automatically restart the reproduction that was discontinued. Accordingly, the user can continuously watch and/or listen the image and/or sound without any operation.

In addition, the aforementioned output method may further include: at the discontinuing, rejecting a request for deleting source data used to reproduce the output data relating to both or either of the image and the sound.

Thus, it is possible to avoid a situation that the source data disappears during the discontinuation and the reproduction cannot be restarted.

Furthermore, the aforementioned output method may further include: at the discontinuing, rejecting a request for ejecting a medium that stores source data used to reproduce the output data relating to both or either of the image and the sound.

Thus, it is possible to avoid a situation that the medium disappear during the discontinuation and the reproduction cannot be restarted.

Furthermore, the aforementioned output method may further include: after the detecting, determining whether or not the strength of the radio wave received from the portable apparatus reach or exceeds the predetermined strength; and in response to an instruction from the portable apparatus, stopping or restarting the determining.

Thus, it is possible to prevent from stopping the output and discontinuing the reproduction against the intension of the user.

Moreover, the aforementioned output method may further include: after the detecting, determining whether or not the strength of the radio wave received from the portable apparatus reach or exceeds the predetermined strength; and upon detecting that the portable apparatus is at rest, stopping the determining.

According to this configuration, it is possible to reduce wasteful processing loads.

Moreover, the aforementioned output method may further include: upon detecting that the portable apparatus gets out of the rest, restarting the determining.

Thus, it is possible to appropriately restart the aforementioned determining.

An output system relating to this embodiment has plural output apparatuses, each of which has a receiver that receives a radio wave from a portable apparatus, and a controller that cause one of the plural output apparatus to restart both or either of image output and sound output, which were stopped.

By using such an output system, when the user who holds the portable apparatus approaches the output apparatus, it is possible to automatically restart both or either of the image output and sound output, which were stopped. Accordingly, the user can continuously watch and/or listen the image (e.g. video) and sound without any operation.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An output method comprising:
receiving, from an output apparatus of plural output apparatuses, notification that represents that a radio wave from a portable apparatus was received; and
first causing the output apparatus that received the radio wave to restart both or either of an image output and a sound output, which were stopped.

2. The output method as set forth in claim 1, further comprising:
selecting an output apparatus that received the radio wave whose strength is greater from among two or more output apparatuses that received the radio wave.

3. The output method as set forth in claim 1, further comprising:
upon detecting that strength of a radio wave received from the portable apparatus by another output apparatus that is outputting both or either of an image and a sound does not reach predetermined strength, second causing the another output apparatus to stop both or either of the image and the sound; and
discontinuing reproduction of data relating to both or either of the image and the sound.

4. The output method as set forth in claim 3, further comprising:
at the first causing, restarting the reproduction that was discontinued.

5. The output method as set forth in claim 3, further comprising:
at the discontinuing, rejecting a request for deleting source data used to reproduce the data relating to both or either of the image and the sound.

6. The output method as set forth in claim 3, further comprising:
at the discontinuing, rejecting a request for ejecting a medium that stores source data used to reproduce the data relating to both or either of the image and the sound.

7. The output method as set forth in claim 3, further comprising:
after the detecting, determining whether or not the strength of the radio wave received from the portable apparatus reach or exceeds the predetermined strength; and
in response to an instruction from the portable apparatus, stopping or restarting the determining.

8. The output method as set forth in claim 3, further comprising:
after the detecting, determining whether or not the strength of the radio wave received from the portable apparatus reach or exceeds the predetermined strength; and
upon detecting that the portable apparatus is at rest, stopping the determining.

9. The output method as set forth in claim 8, further comprising:
upon detecting that the portable apparatus gets out of the rest, restarting the determining.

10. An output system comprising:
a plurality of output apparatuses, wherein each of the plurality of output apparatuses comprises a receiver that receives a radio wave from a portable apparatus; and
a controller that causes one output apparatus of the plurality of output apparatuses to restart both or either of an image output and a sound output, which were stopped, in response to receiving, from the one output apparatus, notification that represents that a radio wave from the portable apparatus.

11. A computer-readable, non-transitory storage medium storing a program for causing a processor to execute a process comprising:
receiving, from an output apparatus of plural output apparatuses, notification that represents that a radio wave from a portable apparatus was received; and
first causing the output apparatus that received the radio wave to restart both or either of an image output and a sound output, which were stopped.
